(19) United States
(12) Patent Application Publication
(10) Pub. No.: US 2018/0247254 A1
(43) Pub. Date: Aug. 30, 2018

(54) SYSTEMS AND METHODS FOR ASSIGNING OUTBOUND LOADS TO CARRIERS

(71) Applicant: Wal-Mart Stores, Inc., Bentonville, AR (US)

(72) Inventors: Andrew B. Millhouse, Gilbert, AZ (US); Timothy J. Burleson, Bentonville, AR (US); John S. Meredith, Bentonville, AR (US)

(21) Appl. No.: 15/883,739

(22) Filed: Jan. 30, 2018

Related U.S. Application Data
(60) Provisional application No. 62/464,548, filed on Feb. 28, 2017.

(51) Int. Cl. G06Q 10/08; H04L 29/06; G06F 3/0482; H04L 12/58; H04L 29/08; H04W 4/14

(52) U.S. Cl. CPC G06Q 10/083; H04L 63/08; G06F 3/0482; H04W 4/14; H04L 51/22; H04L 67/26; G06Q 10/087

(57) ABSTRACT

In some embodiments, methods and systems are provided for facilitating delivery of loads from product distribution facilities to retail stores. A central computing device transmits a notification over a network to computing devices of the carriers to notify the carriers of availability of outbound loads that can be delivered by the carriers from product distribution facilities to the retail stores. After the carriers receive this notification, the carriers are permitted to log in to the central computing device, access a graphical interface including a listing of the available outbound loads, browse through the listing of the available outbound loads in the graphical interface, and accept one or more of the available outbound loads listed in the graphical interface. After an outbound load is accepted by a carrier, the central computing device assigns this outbound load to the carrier.

### CROSS-REFERENCE TO RELATED APPLICATIONS

This application claims the benefit of U.S. Provisional Application No. 62/464,548, filed Feb. 28, 2017, which is incorporated herein by reference in its entirety.

### TECHNICAL FIELD

This invention relates generally to managing available outbound loads and, in particular, to assigning available outbound loads to carriers.

### BACKGROUND

Major retailers utilize carriers for hauling loads of products between various facilities of the retailers. In conventional systems for assigning outbound loads, the retailer manually selects a carrier for hauling a particular outbound load and manually notifies the carrier that an outbound load has been assigned to that carrier. Such manual assignment of outbound loads to carriers can cause friction between carrier and retailer, as well as between the carriers, due to the possibility of biased/preferential assigning of loads to some carriers over others.

### BRIEF DESCRIPTION OF THE DRAWINGS

Disclosed herein are embodiments of systems, apparatuses, methods, and systems pertaining to facilitating delivery of loads from product distribution facilities to retail stores. This description includes drawings, wherein:

FIG. 1 is a diagram of a system of for facilitating delivery of outbound loads from product distribution facilities to retail stores in accordance with some embodiments;

FIG. 2 is a functional diagram of an exemplary central computing device usable with the system of FIG. 1 in accordance with some embodiments;

FIG. 3 is a screen shot of an exemplary first graphical interface of the system of FIG. 1 in accordance with some embodiments;

FIG. 4 is a screen shot of an exemplary second graphical interface of the system of FIG. 1 in accordance with some embodiments; and

FIG. 5 is a flow chart diagram of a process of facilitating delivery of outbound loads from product distribution facilities to retail stores in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems and methods are provided for facilitating delivery of loads from product distribution facilities to retail stores. A central computing device transmits a notification over a network to computing devices of the carriers to notify the carriers of availability of outbound loads that can be delivered by the carriers from product distribution facilities to the retail stores. After the carriers receive this notification, the carriers are permitted to log in to the central computing device, access a graphical interface including a listing of the available outbound loads, browse through the listing of the available outbound loads in the graphical interface, and accept one or more of the available outbound loads listed in the graphical interface. After an outbound load is accepted by a carrier, the central computing device assigns this outbound load to the carrier.

In some embodiments, a system for facilitating delivery of loads from product distribution facilities to retail stores includes a central computing device including a processor-based control circuit and configured for communication with computing devices of a plurality of carriers over a communication network, and an electronic database in communication with the central computing device and the computing devices of the plurality of carriers over the communication network. The central computing device is configured to: transmit a notification over the communication network to the computing devices of the carriers, the notification configured to indicate availability of outbound loads for delivery by the carriers from the product distribution facilities to the retail stores; permit the carriers, after receipt of the notification, and via their respective computing devices, to log in to the central computing device over the communication network to: access a graphical interface including a listing of the available outbound loads; browse through the listing of the available outbound loads in the graphical interface; and accept at least one of the available outbound loads listed in the graphical interface. In response to an acceptance by a carrier of the at least one of the available outbound loads, the central computing device is configured to assign the at least one of the available outbound loads accepted by the carrier to the carrier.

In some embodiments, a method for facilitating delivery of loads from product distribution facilities to retail stores includes: providing a central computing device including a processor-based control circuit and configured for communication with computing devices of a plurality of carriers over a communication network; providing an electronic database in communication with the central computing device and the computing devices of the plurality of carriers over the communication network; transmitting, from the central computing device, a notification over the communication network to the computing devices of the carriers, the notification configured to indicate availability of outbound loads for delivery by the carriers from the product distribution facilities to the retail stores; permitting the carriers, after receipt of the notification, and via their respective computing devices, to log in to the central computing device over the communication network to: access a graphical interface including a listing of the available outbound loads; browse through the listing of the available outbound loads in the graphical interface; and accept at least one of the available outbound loads listed in the graphical interface; assigning to a carrier, via the central computing device and in response to an acceptance by the carrier of the at least one of the available outbound loads, the at least one of the available outbound loads accepted by the carrier.

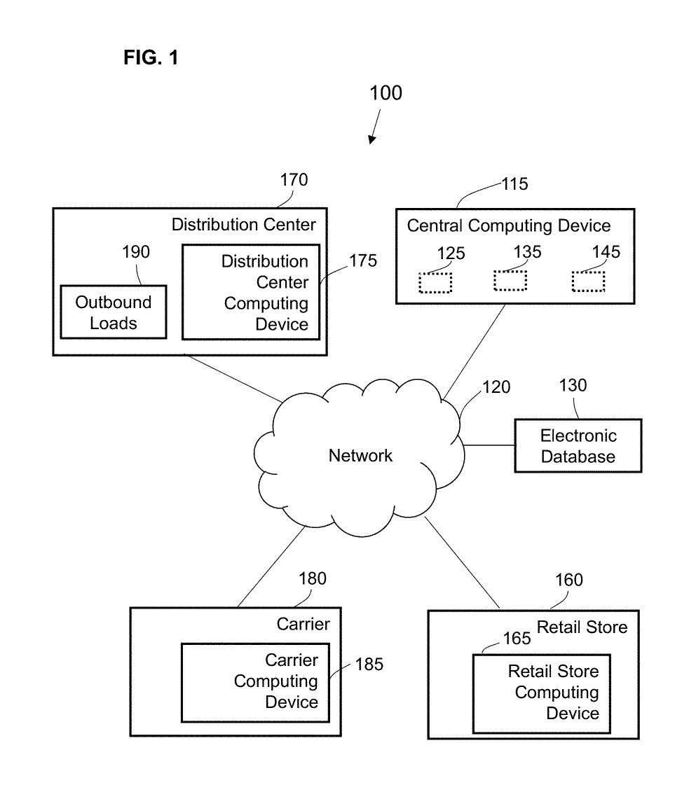

FIG. 1 shows an embodiment of a system 100 for facilitating delivery of loads 190 by carriers 180 from product distribution facilities 170 to retail stores 160. A retail store 160 will be understood to mean any entity operating as a brick-and-mortar physical store and/or a website accessible, for example, via the internet or another network, by way of which products may be ordered by customers. A product distribution facility or a distribution center 170 will be understood to mean any entity that distributes and/or sorts products that are to be delivered by carriers 180 to retail stores 160. Exemplary outbound loads that may be transported by carriers 180 may include, but are not limited to, general-purpose customer goods, as well as consumable products, such as medications, food items, and dietary supplements.

The system 100 depicted in FIG. 1 includes a central computing device 115, which may be implemented as one computer/server at one facility of the retailer (e.g., data warehouse, retail store 160, etc.), or as multiple interconnected computers/servers stored at multiple facilities operated by the retailer, or for the retailer. In some embodiments, the central computing device 115 is a stationary or portable electronic device, for example, a desktop computer, a laptop computer, a tablet, a mobile phone, or any other electronic device including a processor-based control circuit (i.e., control unit). In the embodiment of FIG. 1, the central computing device 115 is configured for data entry and processing as well as for communication with other devices of system 100 via a network 120.

The network 120 may be a wide-area network (WAN), a local area network (LAN), a personal area network (PAN), a wireless local area network (WLAN), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based memory storage. In some embodiments, as will be described below, the central computing device 115 is configured to access an electronic database 130 and/or communicate with a carrier computing device 185 and/or communicate with a distribution center computing device 175 via the network 120 and/or communicate with a retail store computing device 165 to facilitate and/or process the assignment of outbound loads 190 to the carriers 180 for transportation to the retail stores 160.

In the embodiment of FIG. 1, the central computing device 115 is coupled to an electronic database 130. In some embodiments, the electronic database 130 may be configured to store information associated with the outbound loads 190 that are ready to be hauled, that are being hauled, or that were hauled by the carriers 180 from the distribution centers 170 to the retail stores 160. Generally, the electronic database 130 stores electronic information including but not limited to: information associated with the carriers 180 and outbound loads 190 accepted by the carriers 180, information associated with the distribution centers 170 and available outbound loads 190 posted to the system 100 by the distribution centers 170, and information associated with the retail stores 160 and outbound loads 190 delivered to the retail stores 160 by the carriers 180. The electronic database 130 may be stored, for example, on non-volatile storage media (e.g., a hard drive, flash drive, or removable optical disk) internal or external to the central computing device 115, or internal or external to computing devices separate and distinct from the central computing device 115. It will be appreciated that the electronic database 130 may likewise be cloud-based. While the central computing device 115 is shown in FIG. 1 in communication over the network 120 with one electronic database (i.e., database 130), it will be appreciated that the central computing device 115 may be coupled via the network 120 to two or more electronic databases.

In the embodiment illustrated in FIG. 1, the distribution center 170 can access the central computing device 115 over the network 120 via a distribution center computing device 175, which may be a stationary, portable, and/or hand-held electronic device, for example, a desktop computer, a laptop computer, a tablet, a mobile phone, or any other electronic, processor-based device configured for data entry and communication with the central computing device 115. In some aspects, as the distribution center 170 is connecting over the network 120 to the central computing device 115 via the distribution center computing device 175, the central computing device 115 may request a verification of the identity (e.g., username/password) of the distribution center 170. The central computing device 115 may first verify the identity of the distribution center 170 (e.g., by comparing the username/password data entered by the distribution center 170 into the login interface against username/password data stored in the electronic database 130 in association with the distribution center 170). After verification, the distribution center computing device 175 can be permitted access to the central computing device 115.

In some aspects, the central computing device 115 is configured to enable the distribution centers 170 to enter (i.e., upload) electronic data pertaining to their available (i.e., ready for pick up) outbound loads 190 by generating an internet-based form (i.e., graphical interface 125) accessible by the distribution centers 170 via distribution center computing devices 175 logged in to the central computing device 115. It will be appreciated that in some aspects, the graphical interface 125 is configured to permit the distribution centers 170 to upload electronic documents indicating their available outbound loads 190 without having to log in to the central computing device 115. In one aspect, the graphical interface is an internet-based form having a defined uniform resource locator (URL) address and being accessible via an internet browser of the distribution center computing device 175. In another aspect, the graphical interface 135 is generated within a mobile application (app) installed on the distribution center computing device 175, and which permits the distribution center computing device 175 to upload electronic documents to the central computing device 115 without requiring the distribution center computing device 175 to log in to the central computing device 115.

In one embodiment, the graphical interface 135 is configured to enable the distribution center 170 to upload, via the distribution center computing device 175, one or more electronic documents including information indicating the outbound loads 190 available at the distribution center 170 for pick up and hauling by a carrier 180. Electronic documents that can be uploaded to the central computing device 115 can include but are not limited to spreadsheet files (e.g., .xls files, .xlsx files, etc.), document files (e.g., .doc files, .docx files, etc.), or the like. A portion of an exemplary graphical interface 325 that permits a distribution center 170 to upload electronic documents indicating (e.g., by way of a listing in spreadsheet, table, or another suitable format) one or more outbound loads 190 available at the distribution center 170. In some aspects, a listing of outbound loads 190 submitted by the distribution center 170 specifies the parameters relating to the outbound load 190. For example, each outbound load 190 listed in the spreadsheet file uploaded by the distribution center 170 can include electronic data including but not limited to: load identifying information (e.g., load number), total number of pallets, boxes, crates, and/or products in a load; total weight of a load; dimensions (e.g., length, width, height) of a load, etc.

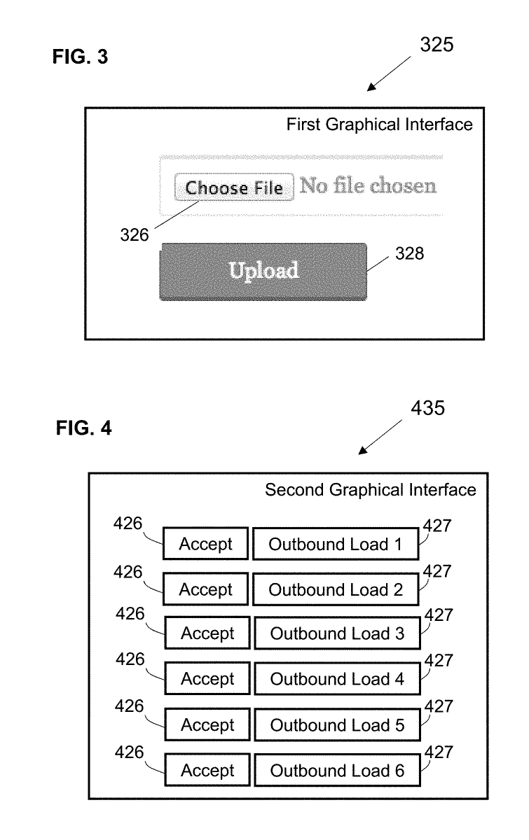

The exemplary portion of the graphical interface 325 illustrated in FIG. 3 includes one a graphical element 326 (i.e., “Choose File” button) that may be clicked by an operator of a distribution center computing device 175 in order to bring up a menu of electronic document files in a file directory on the distribution center computing device 175 for the operator to choose to upload to the central computing device 115. After the operator clicks the file desired for upload (e.g., an Excel spreadsheet file with a file extension 'xlsx or a Microsoft Word file with a file extension .docx), the operator can click the graphical element 328 (i.e., “Upload” button) in order to cause the distribution center computing device 175 to upload the selected file indicating the outbound loads 190 of the distribution center 170 to the central computing device 115. The processing of the electronic document uploaded over the network 120 from the distribution center computing device 175 by the central computing device 115 is discussed in more detail below with further reference to the internal components of the central computing device 115.

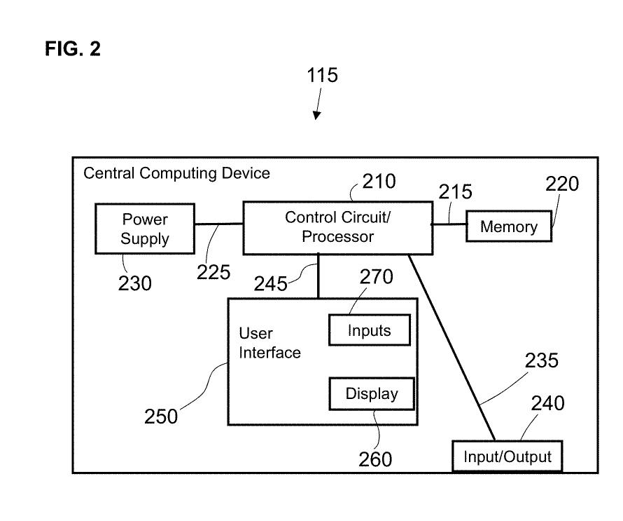

With reference to FIG. 2, an exemplary central computing device 115 configured for use with the systems and methods described herein may include a control circuit 210 including a processor (for example, a microprocessor or a microcontroller) electrically coupled via a connection 215 to a memory 220 and via a connection 225 to a power supply 230. The control unit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control unit 210 of the central computing device 115 can be configured (for example, by using corresponding programming stored in the memory 220 as will be well understood by those skilled in the art) to carry out one or more of the steps, actions, and/or functions described herein. In some embodiments, the memory 220 may be integral to the processor-based control unit 210 or can be physically discrete (in whole or in part) from the control unit 210 and is configured non-transitorily store the computer instructions that, when executed by the control unit 210, cause the control unit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control unit 210 of the central computing device 115 is electrically coupled via a connection 235 to an input/output 240 that can receive signals from electronic devices in communication over the network 120 with the central computing device 115 (e.g., data from the distribution center computing device 175 relating to available outbound loads 190, data from the carrier computing device 185 indicating a selection by the carrier 180 of a particular outbound load 190, etc.). The input/output 240 of the central computing device 115 can also send signals to electronic devices in communication over the network 120 with the central computing device 115 (e.g., distribution center-uploaded data relating to available outbound loads 190 to the electronic database 130, carrier-uploaded post hauling data to electronic database 130, etc.).

In the embodiment shown in FIG. 2, the processor-based control unit 210 of the central computing device 115 is electrically coupled via a connection 245 to a user interface 250, which may include a visual display or display screen 260 (e.g., LED screen) and/or button input 270 that provide the user interface 250 with the ability to permit an operator of the central computing device 115 to manually control the central computing device 115 by inputting commands via touch-screen and/or button operation and/or voice commands to, for example, to review the information of a carrier 180 who accepted an outbound load 190 and/or to review post-hauling data uploaded by a carrier 180. It will be appreciated that the performance of such functions by the processor-based control unit 210 of the central computing device 115 is not dependent on a human operator, and that the control unit 210 may be programmed to perform such functions without a human operator.

In some embodiments, the display screen 260 of central computing device 115 is configured to display various graphical interface-based menus, options, and/or alerts that may be transmitted to the central computing device 115 and displayed on the display screen 260 in connection with various aspects of receiving electronic documents pertaining to available outbound loads 190 uploaded by the distribution center 170 and/or receiving post-hauling data from carriers 180. The inputs 270 of the central computing device 115 may be configured to permit an operator to navigate through the on-screen menus on the central computing device 115. It will be appreciated that the display screen 260 may be configured as both a display screen and an input 270 (e.g., a touch-screen that permits an operator to press on the display screen 260 to enter text and/or execute commands.)

As discussed above, in some aspects, the control circuit 210 of the central computing device 115 is programmed to generate a graphical interface 135 accessible on the central computing device 115 by the distribution center 170 via the distribution center computing device 175. As discussed above, this graphical interface 135 is configured (e.g., by including clickable graphical buttons 326, 328 to permit the distribution center 170, via the distribution center computing device 175, to submit their available outbound loads 190.

In some embodiments, after an electronic document (e.g., a spreadsheet document in .xls or .xlsx format) is uploaded to the central computing device 115 as discussed above, the control circuit 210 of the central computing device 115 is programmed to process each of the one or more electronic documents uploaded by the distribution center computing device 175 to extract information indicating the one or more outbound loads 190 available at the distribution center 170. In one aspect, after the control circuit 210 processes such electronic documents, the control circuit 210 is programmed to upload the extracted information indicating the outbound loads 190 available at the distribution center 170 into the graphical interface 135, and to cause the central computing device 115 to transmit both the electronic documents uploaded by the distribution centers 170 and the information extracted from such electronic documents to the electronic database 130 for storage and/or future retrieval by the central computing device 115 or any other computing device of system 100.

In some embodiments, after the control circuit 210 of the central computing device 115 processes the electronic document uploaded by the distribution center 170 and extracts the available outbound load data therefrom, the control circuit 210 of the central computing device 115 is programmed to transmit (over the network 120) a signal including an electronic alert or notification to the computing devices 185 of multiple carriers 180. In some aspects, the electronic notification sent by the central computing device 115 over the network 120 to the carrier computing devices 185 includes but is not limited to a short message service (SMS) message, an electronic mail (e-mail) message, an instant messenger message, and/or a push notification. The electronic notification, when received by the carrier computing devices 185, indicates to the carriers 180 the availability of outbound loads 190 for delivery by the carriers 180 from the distribution centers 170 to the retail stores 160.

In some embodiments, prior to sending the aforementioned electronic notification to the carrier computing devices 185, the central computing device 115 obtains electronic data representing identifying information of the carriers 180 to which the electronic notification will be sent. While the electronic database 130 stores a listing of all carriers 180 across the country registered with the system 100, in some aspects, the central computing device 115 is configured to determine the carriers 180 available in the geographic vicinity (e.g., 5 miles, 10 miles, 25 miles, 50 miles, 75 miles, 100 miles, etc.) of an available outbound load 190. In other words, in some aspects, the control circuit 210 of the central computing device 115 is programmed to analyze a list of carriers 180 in the geographic vicinity of an outbound load 190, and to determine which carriers 180 are not a good match for picking up the outbound load 190 (e.g., no available truck, the available trucks are too small in size, etc.), and to determine which carriers represent a match for that outbound load 190 (e.g., have one or more trucks available and within an acceptable radius of the outbound load 190). After the control circuit 210 determines which carriers 180 are available and are a match for a given available outbound load, the control circuit 210 transmits the electronic notification indicating availability of that outbound load 190 only to such carriers 180.

As will be described in more detail below, in some embodiments, after the carriers 180 receive this notification of available outbound loads 190 from the distribution center computing device 175, the carriers 180 log in to the central computing device 115 in order to browse through a listing of outbound loads 190 available for acceptance to the carriers 180, and to accept one or more outbound loads 190 for hauling to a retail store 160. In some embodiments, when a carrier 180 initially sets up an online account, the system 100 (e.g., central computing device 115) is configured to permit the carrier 180 to generate a carrier profile including information of the carrier 180 (e.g., name, address, other identifying information (e.g., Standard Carrier Alpha Code (SCAS)), phone number, financial information (e.g., bank account information), truck/trailer information (number and size of trucks/trailers), and the like). In some embodiments, the information associated with the carriers 180 is stored in the electronic database 130 for subsequent retrieval by the central computing device 115 (e.g., when the control circuit 210 is processing carrier information to determine a list of carriers 180 that are a match for a given outbound load available at a given distribution center 170).

A carrier 180 may access the central computing device 115 over the network 120 via a carrier computing device 185, which may be a stationary, portable, and/or hand-held electronic device, for example, a desktop computer, a laptop computer, a tablet, a mobile phone, or any other electronic, processor-based device configured for data entry and communication with the central computing device 115. In some aspects, as the carrier 180 is connecting over the network 120 to the central computing device 115 via the carrier computing device 185, the central computing device 115 may request a verification of the identity (e.g., username/password) of the carrier 180. The central computing device 115 may first verify the identity of the carrier 180 (e.g., by comparing the username/password data entered by the carrier 180 into the login interface against username/password data in the profile of the carrier 180 stored in the electronic database 130). The central computing device 115 then associates the profile of the carrier 180 with the identity of the carrier 180, retrieve carrier account information stored in the profile, and send the carrier account information retrieved from the profile to the central computing device 115 in order to enable the carrier computing device 185 to log in to the central computing device 115.

In some embodiments, after the carrier computing devices 185 are permitted to log in to the central computing device 115, the carriers 180 are permitted to browse through a listing of outbound loads 190 available for acceptance to the carriers 180, which can be presented to the carriers 180 via the second graphical interface 435 shown in FIG. 4, and to accept one or more outbound loads 190 for hauling to a retail store 160. The exemplary central computing device 115 of FIG. 1 is configured to enable the carriers 180 to browse through and accept outbound loads 190 by generating a second graphical interface (135 in FIGS. 1 and 435 in FIG. 4), which may be an internet-based form accessible by the carriers 180 via carrier computing devices 185 logged in to the central computing device 115. In some embodiments, instead of being an internet-based form having a defined uniform resource locator (URL) address and accessible via an internet browser of the carrier computing device 185, the second graphical interface 135 is generated within a mobile application (app) installed on the carrier computing device 185.

A portion of an exemplary graphical interface 435 is illustrated in FIG. 4. The exemplary second graphical interface 435 of FIG. 4 includes one or more text fields 427 listing the outbound loads (e.g., Outbound Load 1, Outbound Load 2, Outbound Load 3, Outbound Load 4, Outbound Load 5, Outbound Load 6) that a carrier 180 can browse through for purposes of selecting to haul from the distribution center 170 to a retail store 160. The exemplary second graphical interface 435 shown in FIG. 4 further includes graphical elements 436 (e.g. “Accept” buttons) that may be clicked by an operator (e.g., employee or manager of the carrier 180) to select from the listing (e.g., by clicking on an appropriate button 436) an outbound load that the carrier 180 is willing to accept for hauling from the distribution center 170 to a retail store 160. In other words, while the second graphical interface 435 is displayed on the carrier computing device 185 that is logged in to the central computing device 115, an operator of the carrier computing device 185 is permitted to select one of the outbound loads (e.g., Outbound Load 3) displayed in the second graphical interface 435 by clicking on an appropriate graphical “Accept” button 436.

In some embodiments, after the operator of the carrier computing device 185 clicks the “Accept” button 436 associated with a given outbound load (e.g., Outbound Load 3), the control circuit 210 of the central computing device 115 is programmed to remove the outbound load 190 accepted by the carrier 180 (i.e., Outbound Load 3) from the listing of available outbound loads 190 displayed in the second graphical interface 435, thereby preventing any other carrier 180 from accepting Outbound Load 3, which has already been accepted for hauling by another carrier 180. In other words, the outbound loads listed in the second graphical interface 435 can be accepted by the carriers 180 on a “first come first served basis,” therefore enabling the carriers 180 to determine which outbound loads 190 they are going to haul to the retail stores 160.

In one aspect, after a carrier 180 accepts a given outbound load 190 as described above, the control circuit 210 of the central computing device 115 is programmed to cause the central computing device 115 to transmit (e.g., over the network 120) to a computing device 185 of the carrier 180, an electronic notification or alert indicating to the carrier 180 that the outbound load 190 accepted by the carrier 180 within the second graphical interface 435 has been formally assigned to the carrier 180 for delivery from the distribution center 170 to the retail store 160. In one aspect, the control circuit 210 is programmed to send an electronic notification to a retail store computing device 165 to provide the retail store 160 with an identification of the carrier 180 who is going to be delivering the outbound load 190 to the retail store 160. Such electronic notifications can include but are not limited to: short message service (SMS) messages, electronic mail (e-mail) messages, instant messenger messages, voice mail messages, and/or push notifications.

In some embodiments, the central computing device 115 is configured to enable a carrier 180 to enter post-hauling data relating to an outbound load 190. In other words, after a carrier 180 completes the hauling of an outbound load 190 from the distribution center 170 to the retail store 160, the carrier is permitted to log in to the central computing device 115 as described above, and to enter electronic information pertaining to various aspects of the hauling of that particular outbound load 190 to the retail store 160. Such electronic information may include, but is not limited to: issues/problems (unreasonable delay at the retail store 160 after the outbound load 190 is hauled to the retail store 160, breakdowns/repairs necessary during the haul, etc.), or any other post-hauling data the carrier 180 deems necessary for entry into the system 100.

In one aspect, the carrier 180 is permitted to enter post-hauling data by uploading an electronic document via the first graphical interface 125 as described above, for example, with reference to FIG. 3. In another aspect, after the carrier 180 logs into the central computing device 115 after an outbound load 190 is marked in the system 100 as having been completed (i.e., delivered to the retail store 160), the control circuit 210 of the central computing device 115 is programmed to generate a third graphical interface 145 including one or more text input fields configured to permit the operator of the carrier computing device 185 to type in all post-hauling data the carrier 180 deems to be relevant to the completed haul. In some embodiments, after the carrier 180 enters post-hauling data (e.g., via the first graphical interface 125 or third graphical interface 145), the control circuit 210 of the central computing device is programmed to cause the central computing device 115 to transmit such post-hauling data to the electronic database 130 over the network 120 for storage and/or future retrieval by the central computing device 115.

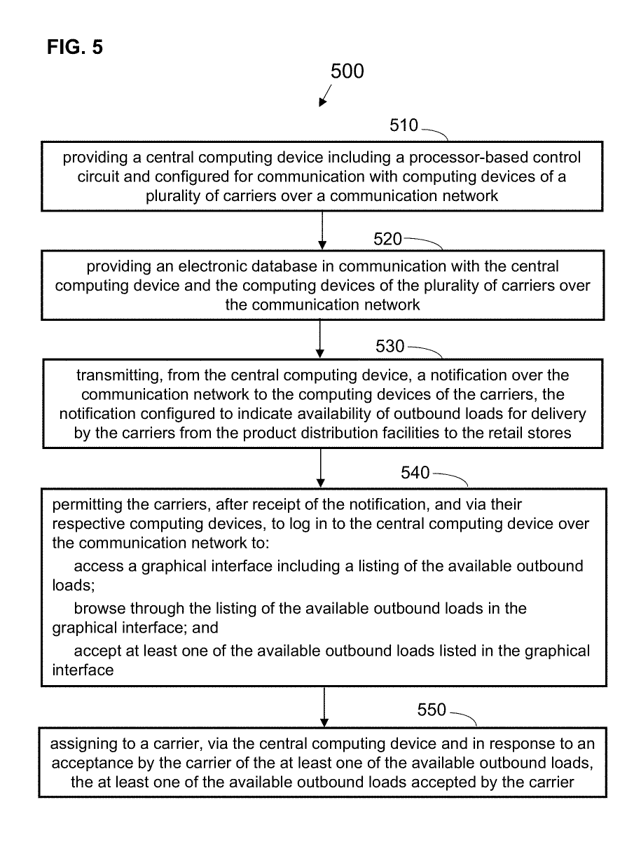

FIG. 5 shows an embodiment of an exemplary method 500 of facilitating delivery of loads from product distribution centers 170 to retail stores 160. The method 500 includes providing a central computing device 115 including a processor-based control circuit 210 and configured for communication with carrier computing devices 185 over a communication network 120 (step 510). In addition, the method 500 of FIG. 5 includes providing an electronic database 130 in communication with the central computing device 115 and carrier computing devices 185 over the communication network 120 (step 520).

As described above, in some embodiments, distribution centers 170 are permitted to upload electronic documents including information indicating the outbound loads 190 available at the distribution centers 170 for hauling by the carriers 180. In some aspects, a distribution centers 170 uploads an electronic document (e.g., a spreadsheet file) via a first graphical interface 125, and the control circuit 210 of the central computing device 115 processes the uploaded document to extract the information (e.g., a listing) of outbound loads 190 available at the distribution center, and to transmit the extracted information for storage to the electronic database 130. In one aspect, as discussed above, the control circuit 210 generates a second graphical interface 135 configured to permit carriers 180 (who are logged in to the central computing device 115 as described above) to browse the listings of available outbound loads 190 and to accept one or more outbound loads 190 for hauling from a distribution center 170 to a retail store 160. Portions of exemplary first graphical interface 325 and second graphical interface 435 are illustrated in FIGS. 3 and 4, respectively, and have been discussed in more detail above.

As discussed above, in one aspect, the method 500 includes processing, via the control circuit 210 of the central computing device 115, each of the electronic documents obtained by the central computing device from the distribution center computing devices 175 to determine a list of carriers 180 that are a match for each of the outbound loads 190 available at the distribution centers 170. For example, the control circuit 210 can analyze the geographic proximity of the carriers 180 stored in the electronic database 130 to a distribution center 170 where an outbound load 190 is available, as well as the availability and hauling capacity of the trucks of the carrier 180, in order to determine which of the carriers 180 are a match for the outbound load 190 (and by the same token, which carriers 180 are not a good match for this particular outbound load 190).

After the control circuit 210 of the central computing device 115 determines which carriers 180 are to be notified of one or more available outbound loads 190 available at one or more distribution centers 170, the exemplary method 500 illustrated in FIG. 5 further includes transmitting, from the central computing device 115, a notification over the communication network 120 to the carrier computing devices 185 in order to indicate to the carriers 180 the availability of outbound loads 190 for delivery by the carriers 180 from the distribution centers 170 to the retail stores 160 (step 530). In one aspect, where the control circuit 210 first determines which carriers 180 stored in the electronic database 130 are a match for a given outbound load 190 and which are not, the method 500 includes transmitting, from the central computing device 115, the notification indicating availability of outbound loads 190 at a distribution center 170 only to the carriers 180 that are a match for the outbound load 190 available at the distribution center 170.

After the carriers 180 receive a notification from the central computing device 115 indicating that outbound loads 190 are available at product distribution centers 170, the carriers 180 are permitted to log in to the central computing device 115, browse through the available outbound loads 190, for example, within a second graphical interface 435 (described in more detail above with reference to FIG. 4), and to accept one or more of the available outbound loads 190 for hauling to one or more retail stores 160 (e.g., via clicking a graphical “Accept” button 426 associated with an outbound load that the carrier 180 would like to accept). To that end, the method 500 of FIG. 5 includes permitting the carriers 180, after receipt of the notification from the central computing device 115, and via their respective computing devices 185, to log in to the central computing device 115 over the communication network 120 to: access a graphical interface 435 including a listing of the available outbound loads 190; browse through the listing of the available outbound loads 190 in the graphical interface 435; and accept at least one of the available outbound loads 190 listed in the graphical interface 435 (step 540).

In some embodiments, after the operator of the carrier computing device 185 clicks the “Accept” button 426 associated with a given outbound load (e.g., Outbound Load 3), the accepted outbound load (i.e., Outbound Load 3) is removed from the listing of available outbound loads 190 displayed in the second graphical interface 435. Thus, carriers 180 are permitted to accept any of the outbound loads 190 listed in the second graphical interface 435 on a “first come first served basis. After an outbound load 190 is accepted by a carrier 180, other carriers 180 logged into the central computing device 115 are prevented from accepting this outbound load 190, and this outbound load 190 becomes the sole responsibility of the carrier 180 who accepted it, and electronic information associating an accepted outbound load 190 with the carrier 180 who accepted that outbound load 190 is transmitted by the central computing device 115 to the electronic database 130 for storage.

In one aspect, after a carrier 180 accepts a given outbound load 190 as described above, the central computing device 115 transmits an electronic notification to a carrier computing device 185 in order to alert the carrier 180 that a given outbound load 190 accepted by that carrier 180 is now assigned to the carrier 180 for hauling from the distribution center 170 to the retail store 160. By the same token, the central computing device 115 can send an electronic notification to the retail store 160 in order to inform the retail store 160 of the identity of the carrier 180 who is going to be delivering the outbound load 190 to the retail store 160.

In some aspects, after a carrier 180 completes a delivery of an outbound load 190 to a retail store 160, the carrier 180 is permitted to log in to the central computing device 115 and to enter post-hauling data relating to this delivery. For example, a carrier 180 wishing (or required) to submit post-hauling data to the central computing device 115 may log in to the central computing device 115 as described above, and to enter (e.g., via the third graphical interface 145) electronic information pertaining to various aspects of the hauling of the outbound load 190 to the retail store 160. For example, the carrier 180 may submit a detention reimbursement request against the retail store 160 if the carrier 180 is delayed during unload at the retail store 160 for an unreasonable period of time due to no fault of the carrier 180. After the post-hauling data is transmitted to the central computing device 115 from the carrier computing device 185, the central computing device 115 transmits the post-hauling data to the electronic database 130 for storage and/or further retrieval. It will be appreciated that the central computing device 115 can also transmit the post-hauling data to the retail store 160, if the feedback from the retail store 160 is required in order for the central computing device 115 to fully process the post-hauling data.

The systems and methods described herein advantageously allow distribution centers to easily post outbound loads while permitting the carriers to easily accept the available outbound loads on a first come first served basis. Such systems and methods not only provide an easy to use system for both distribution centers and carriers, but also prevent distribution centers from exercising bias in assigning outbound loads to the carriers.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for facilitating delivery of loads by carriers from product distribution facilities to retail stores, the system comprising:
a plurality of computing devices of a plurality of carriers, the computing devices of the carriers configured send and receive signals over a communication network;
a plurality of computing devices of a plurality of retail stores, the computing devices of the retail stores configured send and receive signals over the communication network;
a central computing device including a processor-based control circuit and configured for communication with the computing devices of the carriers and with the computing devices of the retail stores over the communication network,
an electronic database in communication with the central computing device, the computing devices of the carriers, and the computing devices of the retail stores over the communication network;
wherein the central computing device is configured to:
generate a graphical interface including a listing of available outbound loads for delivery by the carriers from the product distribution facilities to the retail stores, the graphical interface including a plurality of clickable buttons, each of the clickable buttons being associated with one of the available outbound loads and being configured to permit the carriers to accept at least one of the available outbound loads by clicking on the clickable button associated with the at least one of the available outbound loads;
transmit a notification over the communication network to the computing devices of the carriers, the notification configured to indicate availability of the outbound loads for delivery by the carriers from the product distribution facilities to the retail stores;
permit the carriers, after receipt of the notification, and via their respective computing devices, to log in to the central computing device over the communication network to:
access the graphical interface including the listing of the available outbound loads;
browse through the listing of the available outbound loads in the graphical interface; and
accept at least one of the available outbound loads listed in the graphical interface by clicking on the clickable button associated with the at least one of the available outbound loads;
wherein, in response to an acceptance by a carrier of the at least one of the available outbound loads, the central computing device is configured to:
assign the at least one of the available outbound loads accepted by the carrier to the carrier;
remove the at least one of the available outbound loads accepted by the carrier from the listing of the available outbound loads in the graphical interface; and
restrict another one of the carriers from clicking on the clickable button associated with the at least one available outbound load accepted by the carrier.

2. The system of claim 1, wherein the central computing device is configured to obtain, from computing devices of the product distribution facilities and over the communication network, a plurality of electronic documents including information indicating the outbound loads available at the product distribution facilities.

3. The system of claim 2, wherein the control circuit of the central computing device is configured to:
process each of the electronic documents obtained from the computing devices of the product distribution facilities to extract the information indicating the outbound loads available at the product distribution facilities; and
upload the extracted information indicating the outbound loads available at the product distribution facilities into the graphical interface.

4. The system of claim 3, wherein the electronic database is configured to store the electronic documents obtained from the computing devices of the product distribution facilities and the extracted information indicating the outbound loads available at the product distribution facilities.

5. The system of claim 2, wherein the control circuit of the central computing device is configured to:
process each of the electronic documents obtained by the central computing device from the computing devices of the product distribution facilities to determine a list of carriers that are a match for each of the product distribution facilities; and
transmit the notification indicating availability of outbound loads at a product distribution facility only to the carriers that are a match for the product distribution facility.

6. The system of claim 1, wherein the notification comprises electronic mail, a push notification to a mobile application installed on the computing device of the retailer, and a short-message-service (SMS) message.

7-8. (canceled)

9. The system of claim 1, wherein, in response to the acceptance by the carrier of the at least one of the available outbound loads, the central computing device is configured to transmit an alert over the communication network to the carrier who accepted the at least one of the available outbound loads, the alert indicating that the at least one of the available outbound loads accepted by the carrier is assigned to the carrier for delivery.

10. The system of claim 1, wherein the central computing device is configured to permit the carrier who accepted the at least one of the available outbound loads for delivery to log in to the central computing device after completion of the delivery to upload electronic information associated with the delivery of the at least one of the available outbound loads to at least one of the retail stores.

11. A method for facilitating delivery of loads by carriers from product distribution facilities to retail stores, the system comprising:
providing a plurality of computing devices of a plurality of carriers, the computing devices of the carriers configured send and receive signals over a communication network;
providing a plurality of computing devices of a plurality of retail stores, the computing devices of the retail stores configured send and receive signals over the communication network;
providing a central computing device including a processor-based control circuit and configured for communication with the computing devices of the carriers and with the computing devices of the retail stores over the communication network;
providing an electronic database in communication with the central computing device, the computing devices of the carriers, and the computing devices of the retail stores over the communication network;
generating, via the central computing device, a graphical interface including a listing of available outbound loads for delivery by the carriers from the product distribution facilities to the retail stores, the graphical interface including a plurality of clickable buttons, each of the clickable buttons being associated with one of the available outbound loads and being configured to permit the carriers to accept at least one of the available outbound loads by clicking on the clickable button associated with the at least one of the available outbound loads;
transmitting, from the central computing device, a notification over the communication network to the computing devices of the carriers, the notification configured to indicate availability of the outbound loads for delivery by the carriers from the product distribution facilities to the retail stores;
permitting the carriers, after receipt of the notification, and via their respective computing devices, to log in to the central computing device over the communication network to:
access the graphical interface including the listing of the available outbound loads;
browse through the listing of the available outbound loads in the graphical interface; and
accept at least one of the available outbound loads listed in the graphical interface by clicking on the clickable button associated with the at least one of the available outbound loads;
assigning to a carrier, via the central computing device and in response to an acceptance by the carrier of the at least one of the available outbound loads, the at least one of the available outbound loads accepted by the carrier;
removing, via the central computing device, the at least one of the available outbound loads accepted by the carrier from the listing of the available outbound loads in the graphical interface; and
restricting, via the central computing device, another one of the carriers from clicking on the clickable button associated with the at least one available outbound load accepted by the carrier.

12. The method of claim 11, further comprising obtaining, via the central computing device over the communication network from computing devices of the product distribution facilities, a plurality of electronic documents including information indicating the outbound loads available at the product distribution facilities.

13. The method of claim 12, further comprising:
processing, via the control circuit of the central computing device, each of the electronic documents obtained from the computing devices of the product distribution facilities to extract the information indicating the outbound loads available at the product distribution facilities; and
uploading the extracted information indicating the outbound loads available at the product distribution facilities into the graphical interface.

14. The method of claim 13, further storing, on the electronic database, the electronic documents obtained from the computing devices of the product distribution facilities and the extracted information indicating the outbound loads available at the product distribution facilities.

15. The method of claim 12, further comprising:
processing, via the control circuit of the central computing device, each of the electronic documents obtained by the central computing device from the computing devices of the product distribution facilities to determine a list of carriers that are a match for each of the product distribution facilities; and
transmitting, from the central computing device, the notification indicating availability of outbound loads at a product distribution facility only to the carriers that are a match for the product distribution facility.

16. The method of claim 11, wherein the notification comprises electronic mail, a push notification to a mobile application installed on the computing device of the retailer, and a short-message-service (SMS) message.

17-18. (canceled)

19. The method of claim 11, transmitting, via the central computing device and in response to the acceptance by the carrier of the at least one of the available outbound loads, an alert over the communication network to the carrier who accepted the at least one of the available outbound loads, the alert indicating that the at least one of the available outbound loads accepted by the carrier is assigned to the carrier for delivery.

20. The method of claim 11, further comprising permitting the carrier who accepted the at least one of the available outbound loads for delivery to log in to the central computing device after completion of the delivery to upload electronic information associated with the delivery of the at least one of the available outbound loads to at least one of the retail stores.
